(19) United States
(12) Patent Application Publication
(10) Pub. No.: US 2006/0215542 A1
(43) Pub. Date: Sep. 28, 2006

(54) Method and apparatus for providing single-sideband orthogonal frequency division multiplexing (OFDM) transmission

(76) Inventor: Giridhar D. Mandyam, San Diego, CA (US)

Correspondence Address: DITTHAVONG & MORI, P.C., Suite A, 10507 Braddock Road, Fairfax, VA, 22032, US

(21) Appl. No.: 11/389,713

(22) Filed: Mar. 27, 2006

Related U.S. Application Data
(60) Provisional application No. 60/665,237, filed on Mar. 25, 2005.

(51) Int. Cl. H04J 11/00

(52) U.S. Cl. 370/208; 370/335

(57) ABSTRACT

An approach is provided for utilizing single sideband orthogonal frequency division multiplexing (OFDM) transmission. A first transmission area (e.g., cell in a cellular system) is assigned to use a first single OFDM signal. A second transmission area is assigned to use a second single sideband OFDM signal. The first single sideband OFDM signal is different from the second single sideband OFDM signal, and each of the single sideband OFDM signals is based on sinusoidal transform (e.g., Discrete Cosine Transform or Discrete Sine Transform).

### RELATED APPLICATIONS

This application claims the benefit of the earlier filing date under 35 U.S.C. §119(e) of U.S. Provisional Application Ser. No. 60/665,237 filed Mar. 25, 2005, entitled “Single-Sideband OFDM for Cellular System Deployment”; the entirety of which is incorporated by; reference.

### FIELD OF THE INVENTION

Various exemplary embodiments of the invention relate generally to wireless communications.

### BACKGROUND

Co-channel interference is a frequently occurring problem in wireless systems, notably modem cellular systems, in part because of the paucity of available spectrum. This type of distortion is due to interference from an undesired signal operating on the same band as the desired signal. In cellular systems, different approaches have been explored to address co-channel interference. For instance, in a code division multiple access (CDMA) system, use of differentiated spreading codes are be employed to minimize co-channel interference. In a time division multiple access (TDMA) system, co-channel interference is handled by use of multiple transmission frequencies (where the number of transmission frequencies will be referred to as the “frequency reuse number”). Orthogonal frequency division multiplexing (OFDM) systems do not have an inherent means of combating co-channel interference.

Regarding the CDMA approach to minimizing co-channel interference, a variation of OFDM, known as multicarrier CDMA (MC-CDMA) is one means of incorporating the use of spreading codes to combat co-channel interference. A common design guideline involves constraining the spreading length of the codes used such that the length can be no longer than the coherence bandwidth of the wireless transmission channel. This requirement generally results in the use of short spreading codes, thereby providing little protection against co-channel interference. Moreover, spreading in an OFDM system reduces the peak throughput, which is generally undesirable.

The TDMA approach to alleviate co-channel interference involves increasing the frequency reuse factor beyond 1. This is problematic for OFDM systems in that such systems already require a relatively large transmission bandwidth to ensure sufficient frequency diversity.

Therefore, there is a need for an approach to effectively address co-channel interference in wireless communication systems.

### SUMMARY OF SOME EXEMPLARY EMBODIMENTS

These and other needs are addressed by various embodiments of the invention, in which an approach is presented for implementing single sideband (SSB) orthogonal frequency division multiplexing (OFDM) in a wireless communication system.

According to one aspect of an embodiment of the invention, a method comprises receiving a data vector. The method also comprises transforming the data vector by an inverse of a sinusoidal transform; and extending the transformed vector symmetrically to output orthogonal frequency division multiplexing (OFDM) symbols. The method further comprises generating a single sideband signal representing the OFDM symbols, wherein the single sideband signal is transmitted according to a predetermined scheme to minimize co-channel interference.

According to another aspect of an embodiment of the invention, an apparatus comprises a transform logic configured to transform a received data vector by an inverse of a sinusoidal transform. The apparatus also comprises an add symmetric extension logic configured to extend the transformed vector symmetrically to output orthogonal frequency division multiplexing (OFDM) symbols. A single sideband signal representing the OFDM symbols is generated. The single sideband signal is transmitted according to a predetermined scheme to minimize co-channel interference.

According to another aspect of an embodiment of the invention, a method comprises receiving a single sideband signal that represents orthogonal frequency division multiplexing (OFDM) symbols, wherein the single sideband signal having been transmitted according to a predetermined scheme to minimize co-channel interference, the OFDM symbols representing a symmetric data vector. The method also comprises transforming the OFDM symbols by applying a sinusoidal transform; and outputting the data vector from the transformed OFDM symbols.

According to another aspect of an embodiment of the invention, an apparatus comprises means for receiving a single sideband signal that represents orthogonal frequency division multiplexing (OFDM) symbols, wherein the single sideband signal having been transmitted according to a predetermined scheme to minimize co-channel interference. The OFDM symbols represent a symmetric data vector. The apparatus also comprises means for transforming the OFDM symbols by applying a sinusoidal transform; and means for outputting the data vector from the transformed OFDM symbols.

According to another aspect of an embodiment of the invention, a method comprises assigning a first transmission area to use a first single sideband orthogonal frequency division multiplexing (OFDM) signal. The method also comprises assigning a second transmission area to use a second single sideband OFDM signal. The first single sideband OFDM signal is different from the second single sideband OFDM signal, and each of the single sideband OFDM signals is based on sinusoidal transform.

According to yet another aspect of an embodiment of the invention, a system comprises a processor configured to assign a first transmission area to use a first single sideband orthogonal frequency division multiplexing (OFDM) signal. The processor is further configured to assign a second transmission area to use a second single sideband OFDM signal. The first single sideband OFDM signal is different from the second single sideband OFDM signal, and each of the single sideband OFDM signals is based on sinusoidal transform.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a flowchart of a process for utilizing single-sideband (SSB) orthogonal frequency division multiplexing (OFDM) in a radio communication system, in accordance with an embodiment of the invention;

FIG. 2 is a diagram of an SSB OFDM transceiver system, according to an embodiment of the invention;

FIG. 3 is an exemplary OFDM transmission system utilizing Discrete Fourier Transform (DCT), according to one embodiment of the invention;

FIG. 4 is a diagram of an OFDM system configured to utilize sinusoidal transforms for single-sideband (SSB) modulation, according to an embodiment of the invention;

FIG. 5 is a diagram of an OFDM system configured to provide interspersed transforms, according to an embodiment of the invention;

FIGS. 6A and 6B are diagrams of circuitry for supporting exemplary SSB scenarios for, respectively, a two-sector layout and a four-sector layout, according to various embodiments of the invention;

FIGS. 7A and 7B are diagrams showing exemplary SSB scenarios for, respectively, a two-sector layout and a four-sector layout, according to various embodiments of the invention;

FIG. 8 is a diagram of hardware that can be used to implement various embodiments of the invention;

FIGS. 9A and 9B are diagrams of different cellular mobile phone systems capable of supporting various embodiments of the invention;

FIG. 10 is a diagram of exemplary components of a mobile station capable of operating in the systems of FIGS. 9A and 9B, according to an embodiment of the invention; and

FIG. 11 is a diagram of an enterprise network capable of supporting the processes described herein, according to an embodiment of the invention.

### DESCRIPTION OF THE PREFERRED EMBODIMENT

An apparatus, method, and software for utilizing single-sideband (SSB) orthogonal frequency division multiplexing (OFDM) in a radio communication system are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Further, although the embodiments of the invention are discussed with respect to a spread spectrum system, it is recognized by one of ordinary skill in the art that the embodiments of the inventions have applicability to any type of radio communication system as well as wired networks. Additionally, it is contemplated that the protocols and processes described herein can be performed not only by mobile and/or wireless devices, but by any fixed (or non-mobile) communication device (e.g., desktop computer, network appliance, etc.) or network element or node.

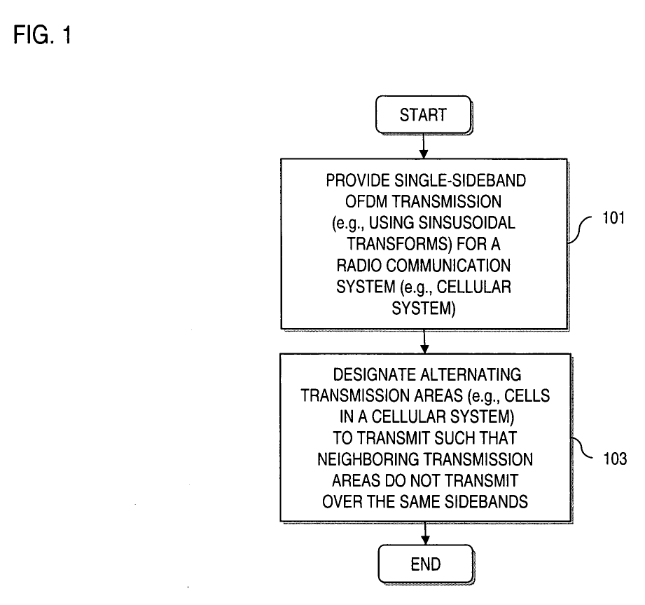

FIG. 1 is a flowchart of a process for utilizing single-sideband orthogonal frequency division multiplexing (OFDM) in a radio communication system, in accordance with an embodiment of the invention. OFDM provides a means of achieving high spectral efficiency in a cellular environment. However, OFDM could have a perceivable disadvantage with respect to systems such as code division multiple access (CDMA) when only one transmission frequency is available in the system (i.e., frequency reuse of 1). Techniques such as frequency hopping or OFDMA (orthogonal frequency division multiple access) have been proposed to combat the co-channel interference experienced in a cellular system with reuse of 1, but these approaches often result in a loss of spectral efficiency due to the partitioning of the available transmission bandwidth.

One proposal for a cdma2000 1×EV-DO (Evolution Data Only) system provides a mechanism of using OFDM for broadcast services in the context of the 1×EV-DO CDMA system and retaining the frequency reuse factor of 1. However, this is achieved by utilizing a guard interval that adds 25% overhead to the OFDM transmission. This overhead is needed to minimize co-channel interference from other cells given the constraint that base station transmissions in 1×EV-DO are time-staggered with respect to each other by offsets several times larger than the worst-case expected delay spread.

Various exemplary embodiments of the present invention use a single sideband (SSB) OFDM scheme to reduce the co-channel interference and to provide spectral efficiency in an OFDM wireless network. Such exemplary embodiments provide a means of OFDM transmission in cellular environments without sustaining the type of co-channel interference normally present in OFDM cellular systems. The process of FIG. 1 can achieve a frequency reuse factor of 2 for the wireless network (in an OFDM system that normally would have a frequency reuse factor of 1). For the purposes of illustration, the various embodiments of the invention are described in the context of the Third Generation Partnership Project 2 (3GPP2) standards; however, the examples of the invention are not restricted for use with cdma2000 networks, and are generally applicable to other types of networks.

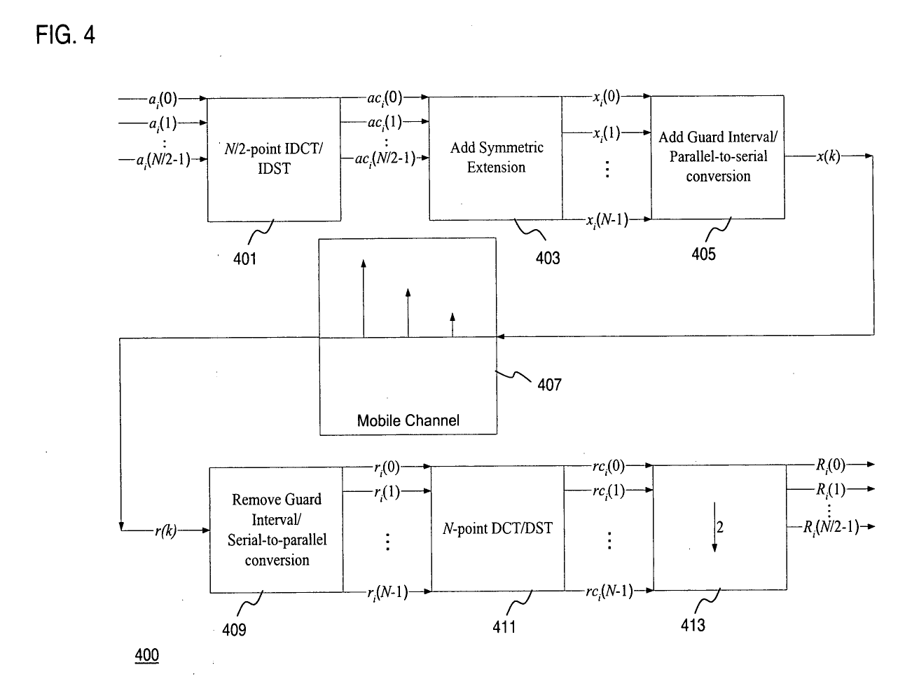

Accordingly, as shown in FIG. 1, single sideband (SSB) orthogonal frequency division multiplexing (OFDM) is provided within a radio (or wireless) communication system (e.g., cellular system), as in step 101. In other words, the process employs the properties of sinusoidal transforms to achieve a frequency reuse factor of 2 and to combat co-channel interference. This approach exploits the properties of sinusoidal transforms for OFDM when the vector of data to be transmitted exhibits some form of symmetry. By contrast, traditional OFDM systems, such as those defined in the Institute of Electrical & Electronics Engineers (IEEE) 802.11 a/g and IEEE 802.16 standards, are based on multicarrier modulation using discrete Fourier transform (DFT). This approach permits simple zero-forcing equalization, and provides diversity in a frequency selective transmission channel. The details of the sinusoidal transform is more fully described in FIG. 4.

In step 103, the process designates alternating transmission areas within the wireless network (e.g., cells in the cellular system) to transmit such that neighboring (or directly adjacent) transmission areas do not transmit over the same sidebands.

The above process addresses the co-channel interference issue within OFDM systems, particularly those systems that are overlaid onto cellular systems that employ a reuse factor of 1.

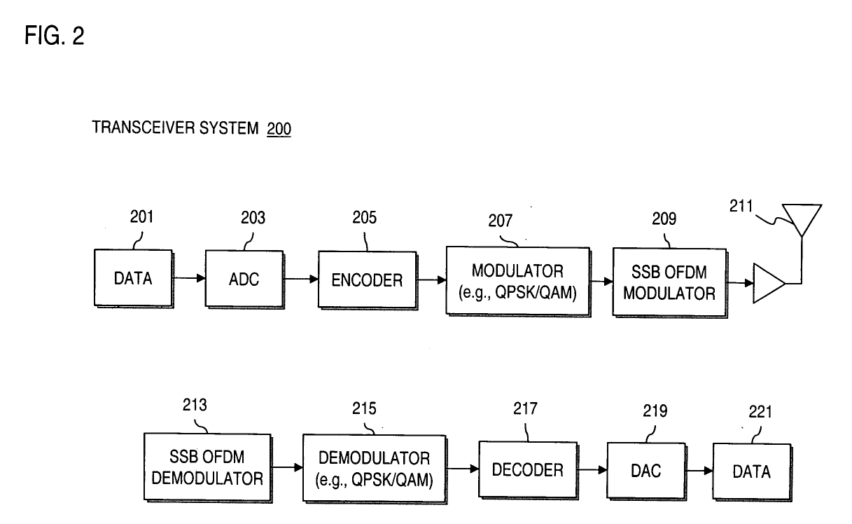

FIG. 2 is a diagram of an SSB OFDM transceiver system, according to an embodiment of the invention. An SSB OFDM transceiver system 200 includes a transmit chain and a receiver chain. The transmit chain includes a data source 201, which outputs to an Analog-to-Digital converter (ADC) 203. The ADC 203 couples to an encoder 205 for encoding the digital signals, wherein the encoded signals are modulated using a modulator 207. The modulator 207, in various embodiments, implements a modulation scheme such as Quadrature Phase Shift Keying (QPSK) or Quadrature Amplitude Modulation (QAM). The signals from the modulator 207 is further fed into an SSB OFDM modulator 209 and then transmitted by an antenna system 211.

On the receiver side, received signals are processed by an SSB OFDM demodulator 213, and provided as input to a demodulator 215 for further demodulation according to the designated modulation scheme, e.g., QPSK or QAM. The demodulated signals are then decoded by a decoder 217. A Digital-to-Analog converter (DAC) converts the decoded signals to analog signals representing received data 221.

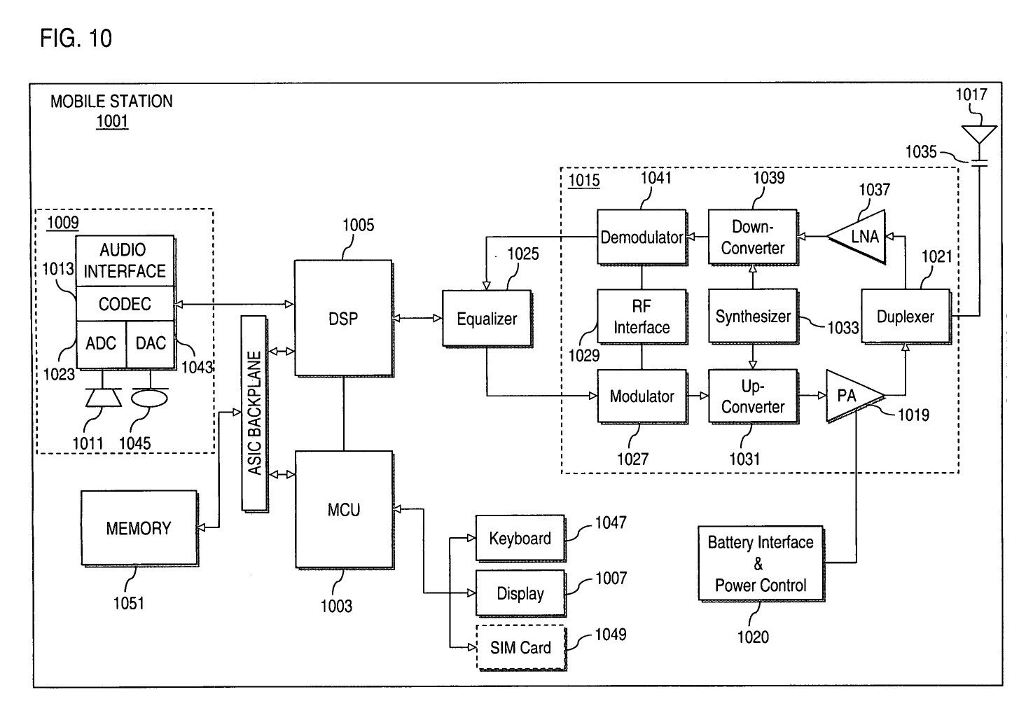

It is contemplated that the SSB OFDM circuitry, which can encompasses a Digital Signal Processor (DSP), software, electronics (such as an integrated circuit or semiconductor device), and/or other hardware, may be implemented in an electronic device, such as a mobile phone handset or station (shown in FIG. 10), a portable computer, a base station, an access point, a base station modem, a base station controller, base station equipment, a base station component, or in equipment that supports the base station or mobile handset, etc.

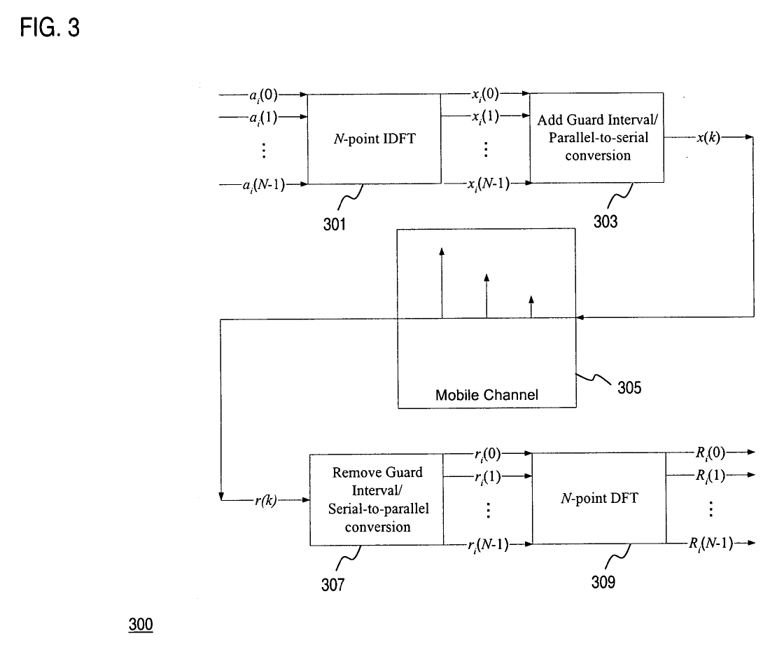

FIG. 3 is an exemplary OFDM transmission system utilizing Discrete Fourier Transform (DCT), according to one embodiment of the invention. With reference to OFDM transmission system 300, {aᵢ(0),aᵢ(1), . . . ,aᵢ(N−1)} comprises the input data vector for OFDM symbol i, {xᵢ(0),xᵢ(1), . . . ,xᵢ(N−1)} the actual OFDM symbol to be transmitted, x(k) the information transmitted after addition of the guard interval, r(k) the received data, {rᵢ(0),rᵢ(1), . . . ,rᵢ(N−1)} the received vector after elimination of the guard interval, and {Rᵢ(0),Rᵢ(1), . . . ,Rᵢ(N−1)} the demodulated information vector.

The input data vector, {aᵢ(0),aᵢ(1), . . . ,aᵢ(N−1)}, is provided to an N-point Inverse Discrete Fourier Transform (IDFT) logic 301. The IDFT logic 301 outputs the OFDM symbols, {xᵢ(0),xᵢ(1), . . . ,xᵢ(N−1)}, which are processed by an Add Guard Interval/Parallel-to-Serial Conversion logic 303. The logic 303 adds a guard interval to the OFDM symbols, and converts the parallel data stream to a serial stream, x(k). The signal, x(k), is transmitted over a mobile channel 305.

The received signal, r(k), is converted back to a parallel stream by a Remove Guard Interval/Serial-to-Parallel conversion logic 307. The received data, {rᵢ(0),rᵢ(1), . . . ,rᵢ(N−1)}, are next fed to an N-point Discrete Fourier Transform (DFT) logic 309, which outputs the demodulated information vector, {Rᵢ(0),Rᵢ(1), . . . ,Rᵢ(N−1)}.

Two features of the transmission system 300 are noted in the design of other multicarrier systems: (1) the use of the cyclic prefix, which allows for simple channel equalization at the receiver, and (2) the need for quadrature transmission even for pulse amplitude modulated (PAM) signaling, due to the use of a discrete Fourier transform.

The invention, according to various embodiments, employs alternatives to the DFT for multicarrier modulation for OFDM transmission, as described in FIG. 4.

FIG. 4 is a diagram of an OFDM system configured to utilize sinusoidal transforms for single-sideband (SSB) modulation, according to an embodiment of the invention. The OFDM system 400, in contrast to the OFDM system 300 of FIG. 3, exploits the fact that symmetrically extended inputs to the inverse transformation operation can also allow for use of a cyclic extension. In other words, the simple equalization that is possible in DFT-based OFDM systems (e.g., system 300) is also possible when using transformations such as the discrete cosine transform (DCT) or discrete sine transform (DST).

Sinusoidal transforms other than the DFT do not have cyclic shift (and therefore cyclic convolution) properties in and of themselves. However, cyclic shift properties arise when asymmetric extension is applied. Sinusoidal transforms such as the DCT and DST can be represented in terms of the generalized discrete Fourier transform (GDFT) when applied to a symmetrically extended sequence. The GDFT is defined for any two real numbers and as

$${G}_{a , b} [ m ] = {\sum }_{l = 0}^{N - 1} \frac{1}{\sqrt{N}} {ⅇ}^{- j \frac{2 π}{N} ( m + a ) ( l + b )} x [ l ]$$

In the case of the DCT first, it is observed that a symmetric extension of the input vector to a DCT operation will result in half of the subcarriers being equivalent to zero. This can be seen from the following definition of the DCT:

$$C [ m ] = {\sum }_{l = 0}^{N - 1} \sqrt{\frac{{k}_{m}}{N}} cos ( \frac{π ( 2 l + 1 ) m}{2 N} ) x [ l ] , {k}_{m} = \{ \begin{matrix}1 , m = 0 \\ 2 , m \neq 0\end{matrix}$$

The N-length input vector is x[l], the N-length output vector is C[m], and kₘ is a scaling constant that is dependent on the subcarrier index m.

The DST is defined as follows:

$$S [ m ] = {\sum }_{l = 0}^{N - 1} \frac{{k}_{sm}}{N} sin ( \frac{π ( 2 l + l ) ( m + 1 )}{2 N} ) x [ l ] , {k}_{sm} = \{ \begin{matrix}2 , m = N - 1 \\ 2 \sqrt{2} , m \neq N - 1\end{matrix}$$

Under this scenario, an input data vector, {aᵢ(0),aᵢ(1), . . . ,a₁(N/2−1)}, is input to an N/2-point Inverse Discrete Cosine Transform (IDCT)/Inverse Discrete Sine Transform (IDST) logic 401, which outputs the following vector: {acᵢ(0),acᵢ(1), . . . ,acᵢ(N/2−1)}, where

$$a {c}_{i} ( k ) = \frac{1}{\sqrt{N}} {\sum }_{n = 0}^{\frac{N}{2} - 1} {a}_{i} ( n ) \sqrt{{k}_{n}} cos ( \frac{π ( 2 k + 1 ) n}{N} ) , \\ 0 \leq k \leq \frac{N}{2} - 1. \\$$

If IDST is used, the result is as follows:

$$a {c}_{i} ( k ) = \frac{2}{\sqrt{N}} {\sum }_{n = 0}^{\frac{N}{2} - 1} {a}_{i} ( n ) {k}_{sn} sin ( \frac{π ( 2 k + 1 ) ( n + 1 )}{N} ) , \\ 0 \leq k \leq \frac{N}{2} - 1.$$

The appropriate vector is then provided to an Add Symmetric Extension logic 403, which symmetrically extends the input vector to OFDM symbols, {xᵢ(0),xᵢ(1), . . . ,xᵢ(N−1)}. The actual transmitted symbol (excluding the guard interval) is as follows:

$${x}_{i} ( k ) = a {c}_{i} ( k ) , 0 \leq k \leq \frac{N}{2} - 1 , and$$

$${x}_{i} ( k ) = \pm a {c}_{i} ( N - 1 - k ) , \frac{N}{2} \leq k \leq N - 1.$$

Symmetric extension involves the replicating of a sequence such that the resultant sequence is either symmetric or asymmetric. The consequence of such an extension is the reduction in throughput by a factor of at least one-half when compared to a DFT matrix. Therefore, these types of transforms (when used with a cyclic prefix) can be considered as an alternative to the DFT only for wireless channel profiles where a potential gain in overall throughput (taking into account the throughput-reducing effects of the symmetric extension) justifies their use.

As seen in the figure, the OFDM symbols are fed to an Add Guard Interval/Parallel-to-Serial Conversion logic 405 (or simply denoted as “guard interval and conversion logic”), which adds guard intervals. The output vector for IDCT operation (when the guard interval is G time domain samples) is as follows:

$${x}_{i} ( k ) = \frac{1}{\sqrt{N}} {\sum }_{n = 0}^{\frac{N}{2} - 1} {a}_{i} ( n ) \sqrt{{k}_{n}} cos ( \frac{π ( 2 k + 1 ) n}{N} ) , \\ 0 \leq k \leq \frac{N}{2} - 1 , \\ {x}_{i} ( k ) = \frac{1}{\sqrt{N}} {\sum }_{n = 0}^{\frac{N}{2} - 1} {a}_{i} ( n ) \sqrt{{k}_{n}} cos ( \frac{π ( 2 ( N - k - 1 ) + 1 ) n}{N} ) , \\ \frac{N}{2} \leq k \leq N - 1 , \\ {x}_{i} ( k ) = {x}_{i} ( N + k ) , - G \leq k < 0.$$

The resultant serial stream, x(k) is transmitted over a mobile channel 407.

The received signal, r(k), is received and converted back to a parallel stream, {rᵢ(0),rᵢ(1), . . . ,rᵢ(N−1)}, by a Remove Guard Interval/Serial-to-Parallel conversion logic 409.

In the case of the DCT, the last G elements are used to form a cyclic extension so that it is length N+G. Neglecting any additive noise in the wireless channel, if the channel is of delay spread equivalent to OFDM samples and has a static channel impulse response represented by the hₘ, the received sequence may be expressed as:

$$r ( k ) = {\sum }_{i = - ∞}^{∞} {\sum }_{m = 0}^{M - 1} {h}_{m} {x}_{i} ( k - m - i ( N + G ) ) .$$

The received data, {rᵢ(0),rᵢ(1), . . . ,rᵢ(N−1)}, are provided to an N-point Discrete Cosine Transform (DCT)/Discrete Sine Transform (DST) logic 411. Assuming perfect synchronization at the receiver, the received sequence may be rearranged with respect to each OFDM symbol:
rᵢ(k)=r(i(N+G)+k), −G≦k<N.

The logic 411 generates the following received data vector: {rcᵢ(0),rcᵢ(1), . . . ,rcᵢ(N−1)}. This vector produces the demodulated information vector, {Rᵢ(0),Rᵢ(1), . . . ,Rᵢ(N/2−1)}. The logic block 413 shows the symbol reduction associated with DCT and DST. It is noted that the various logic 401-413 are shown as separate functional modules; however, it is recognized that such logic 401-413 can be implemented in any number of modules and combinations.

Although symmetric-extension reduces the effective throughput in half versus a conventional OFDM system, the use of the DCT or DST along with PAM signaling makes SSB modulation possible. It should also be noted that a conjugate-symmetric extension applied to the input vector in a DFT-based OFDM system can enable SSB modulation. Further details of the DCT and DST are described in Giridhar D. Mandyam, “Sinusoidal Transforms in OFDM Systems”, IEEE Transactions on Broadcasting, Vol. 50, No. 2, pp. 172-184, June 2004, which is incorporated herein by reference in its entirety.

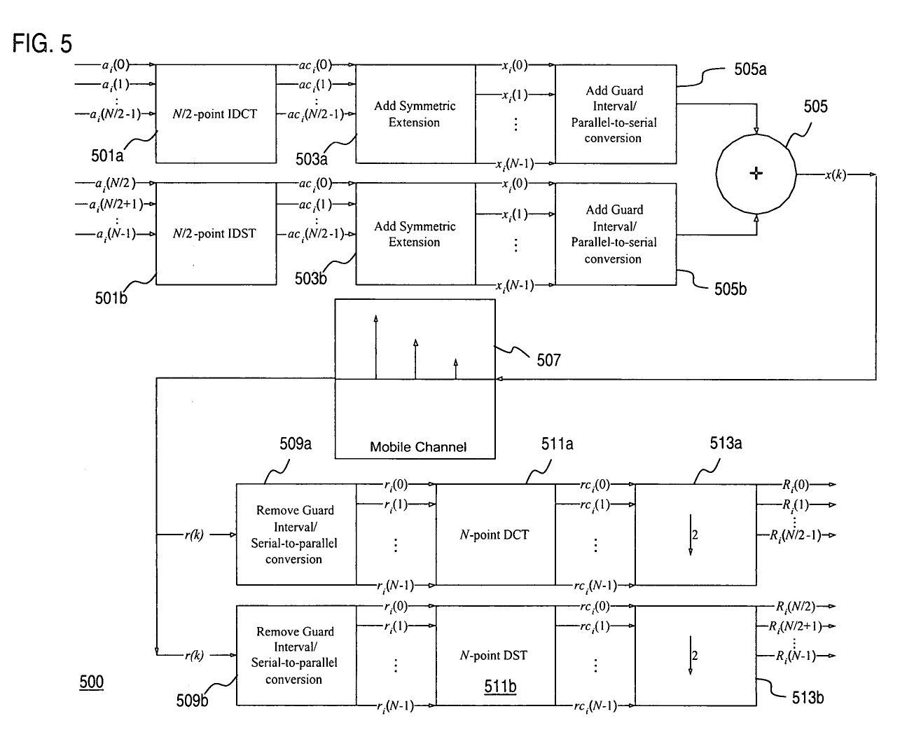

Moreover, another form of OFDM transmission ”recovers” the throughput lost via the systemic extension: the interspersed transform system of FIG. 5.

FIG. 5 is a diagram of an OFDM system configured to provide interspersed transforms, according to an embodiment of the invention. When a symmetric (or antisymmetric) extension is employed, the DCT and DST yield zero odd coefficients and zero even coefficients, respectively. Therefore, in a flat fading channel, half of the usable throughput when employing either one of these transforms is wasted (it should be clarified that in frequency selective channels, the usable throughput is not wasted as a result of symmetric extensions, due to the ability to take advantage of a cyclic prefix). One possible alternative is to “intersperse” the transforms, thus transmitting DCT coefficients for even subcarrier indices and DST coefficients for odd subcarrier indices. This kind of transmission method, as supported by OFDM system 500, results in a signal that is totally recoverable in the flat fading channel due to the fact that the DCT coefficients and DST coefficients appear over disjoint sets of subcarriers.

OFDM system 500 exploits the following properties of DCT and DST based OFDM systems: (1) a symmetrically-extended input vector applied to a DCT based OFDM system results in only the even-indexed subcarriers having non-zero values; and (2) an antisymmetrically-extended input vector applied to a DST based OFDM system results in only the odd-indexed subcarriers having non-zero values. It is noted that although this approach does not suffer the throughput reduction due to symmetric extensions, in a frequency selective channel the fact that the DCT is not orthogonal to an IDST or a DST is not orthogonal to an IDCT results in a phenomenon known as intertransform interference (ITI). However, it is contended that the destructive effects of ITI are outweighed by the spectral advantages of SSB transmission when compared to the conventional DFT-based OFDM system.

As seen in FIG. 5, an input data vector is partitioned such that one portion {aᵢ(0),aᵢ(1), . . . ,aᵢ(N/2−1)} is provided to an N/2-point Inverse Discrete Cosine Transform (IDCT) logic 501a and another portion {aᵢ(N/2),aᵢ(N/2+1), . . . ,aᵢ(N−1)} is supplied to an Inverse Discrete Sine Transform (IDST) logic 501b. Add Symmetric Extension logic 503a and Add Symmetric Extension logic 503b individually process corresponding vectors {acᵢ(0),acᵢ(1), . . . ,acᵢ(N/2−1)} to respectively output OFDM symbols, {xᵢ(0),xᵢ(1), . . . ,xᵢ(N−1)}. Each symbol vector is provided to Add Guard Interval/Parallel-to-Serial Conversion logic 505a and Add Guard Interval/Parallel-to-Serial Conversion logic 505b for addition of guard intervals. The outputs from the logic 505a and logic 505b are combined by an adder 505 to yield a serial stream, x(k) that is transmitted over a mobile channel 507.

Thereafter, the received signal, r(k), is received and converted back to a parallel stream, {rᵢ(0),rᵢ(1), . . . ,rᵢ(N−1)}, by a Remove Guard Interval/Serial-to-Parallel conversion logic 509a, which also removes the guard intervals. Similarly, a Remove Guard Interval/Serial-to-Parallel conversion logic 509b processes the received signal. The received data, {rᵢ(0),rᵢ(1), . . . ,rᵢ(N−1)}, from the logic 509a are provided to an N-point Discrete Cosine Transform (DCT) logic 511a. Additionally, the received data, {rᵢ(0),rᵢ(1), . . . ,rᵢ(N−1)}, from the logic 509b are provided to an N-point Discrete Sine Transform (DST) logic 511b. Subsequently, the logic 513a and 513b show conceptually the reduction in symbols (or throughput) such that the resultant demodulated information vectors are {Rᵢ(0),Rᵢ(1), . . . ,Rᵢ(N/2−1)} and {Rᵢ(N/2),R₁(N/2+1), . . . ,Rᵢ(N−1)}, respectively.

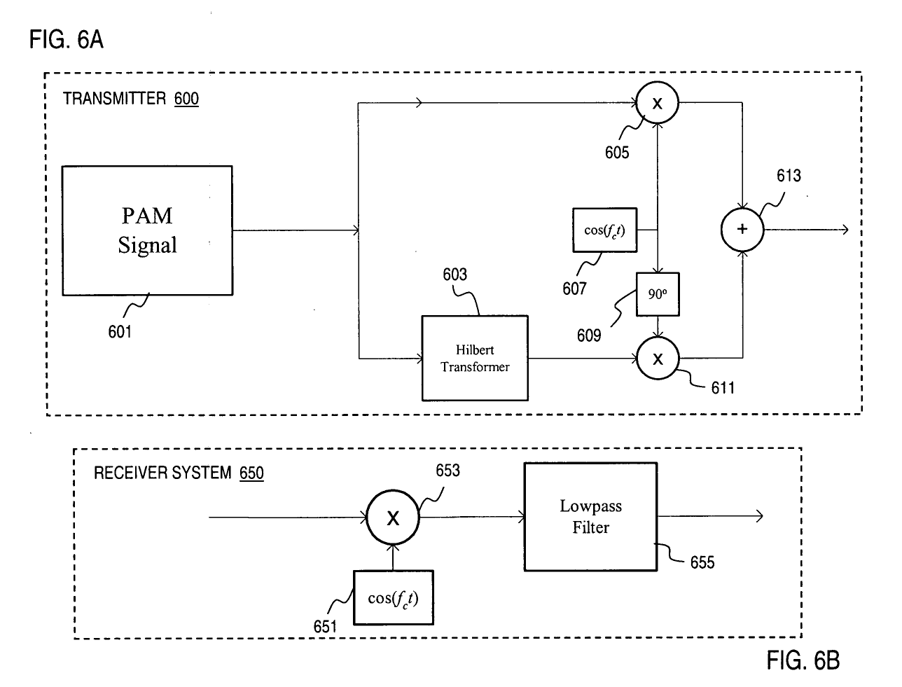

FIGS. 6A and 6B are diagrams of circuitry for supporting exemplary SSB scenarios for, respectively, a two-sector layout and a four-sector layout, according to various embodiments of the invention. SSB is desirable, according to various embodiments, for pulse-amplitude modulation (PAM) due to its spectral efficiency. SSB operates under this principle that PAM yields a symmetric spectrum when modulating a carrier signal, therefore yielding two identical sidebands. Therefore, under noiseless channel conditions the second sideband contains redundancy that is not necessary for reconstruction at the receiver. Thus, the challenge in developing an SSB transmitter involves the design of, for example, the Hilbert transformer. This requires a filter that shifts the phase of the input signal −90 degrees for positive frequencies and +90 degrees for negative frequencies without affecting the magnitude response. However, this is part of the signal processing necessary to ensure only one sideband is sent over the air, thus improving the spectral efficiency of the transmitted waveform.

In an exemplary embodiment, an SSB transmitter 600, shown in FIG. 6A, includes a pulse-amplitude modulation (PAM) module 601 that outputs a PAM signal to a Hilbert transformer 603. The PAM signal is also provided to a mixer 605, which receives input from an oscillator 607. The output from the oscillator 607 is also phase shifted by 90 degrees by shifter 609, which supplies the shifted signal to a mixer 611. The mixer 611 combines this shifted signal with the output of the Hilbert transformer 603; the resultant signal is then added via adder 613 with the output of the mixer 605.

Under this arrangement, two out-of-phase signals with the same magnitude can be obtained. Therefore, a frequency reuse factor of 2 can be obtained in an SSB OFDM system, while a conventional DFT-based OFDM system usually has a frequency reuse factor of 1. In a cellular system, for example, neighboring cells can transmit SSB signals over either I (Inphase)-band (In-phase) or Q (Quadrature)-band, as long as they do not transmit over the same sideband as much as possible, to minimize intercell interference.

In FIG. 6B, a SSB receiver 650 includes an oscillator 651 in conjunction with a mixer 653 to downshift the received signal. The resultant signal is sent through a low pass filter 655 to yield the single-sideband signal.

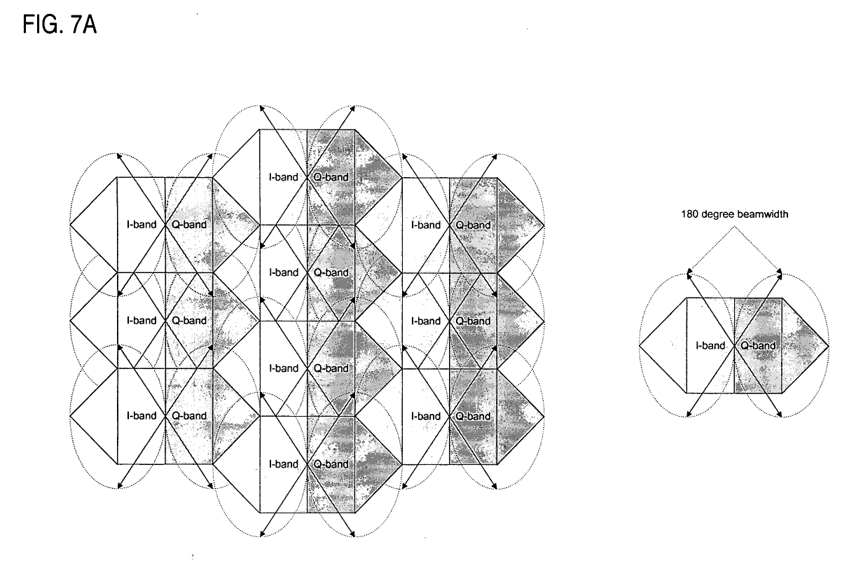

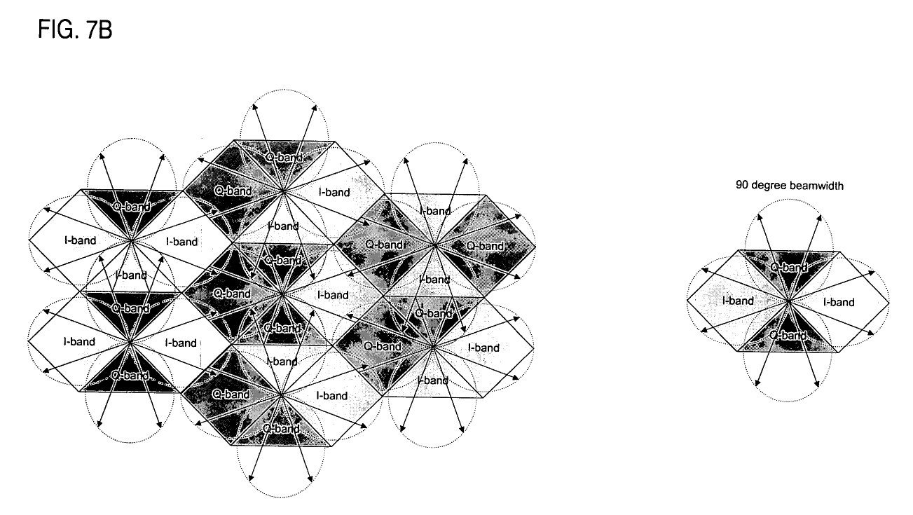

FIGS. 7A and 7B are diagrams showing exemplary SSB scenarios for, respectively, a two-sector layout and a four-sector layout, according to various embodiments of the invention. SSB modulation and associated spectrally-efficient transmission methods can be deployed in a variety of systems. For instance, a PAM transmission system based on SSB, 8-VSB (8-PAM vestigial sideband modulation), is the basis for the high-definition television (HDTV) broadcast standard adopted in the United States. However, 8-VSB is a system that suffers in frequency-selective channels and can require complicated equalization. Therefore, the combination of SSB with its spectral efficiency and OFDM with its simple equalization can provide for a robust transmission technique for wireless systems. Moreover, an SSB overlay system (i.e., SSB used in a system that already has transmission bandwidth for double sideband modulation) over a frequency reuse 1 cellular deployment can provide the possibility of implementing a frequency reuse factor of 2 (as in FIGS. 7A and 7B).

Consequently, the possibility for SSB transmission allows for overlays in an existing cellular system such that it is possible to effect a frequency reuse factor of 2 in the same bandwidth that a conventional DFT-based OFDM system may be deployed. As mentioned, OFDM systems in cellular environments may suffer heavily from co-channel interference. Unlike CDMA systems, OFDM systems have no inherent mechanisms to combat intercell interference when the number of frequency channels available for transmission is 1 (i.e., reuse factor 1). However, as discussed, an SSB-OFDM system, according to certain embodiments, can impose a system constraint whereby neighboring cells may transmit over the I-band or Q-band in such a way as to minimize intercell interference. This can be thought of as a reuse factor of 2.

For instance, a deployment with reuse factor of 2 is provided in FIG. 7A assuming two sectors per cell. The antenna radiation patterns at the base stations (assumed to be at the center of each cell), when assumed to not exceed 180 degrees, result in a separation of at least the cell diameter between the desired signal source and a co-channel interferer. This is comparable to the classic scenario of reuse 3 with no sectorization.

The usage of SSB modulation can also be extended to a deployment of 4 sectors per cell—for a reuse cluster size of 2 (see FIG. 7B). Although the minimum distance between any desired signal and co-channel interferer is still one full cell diameter, there are several cases where the distance is larger, thus providing for potential improvement for system capacity with respect to the 2 sector case.

To verify that single-sideband modulation interference does not provide significant link-level interference in the scenarios presented in FIGS. 7A and 7B, simulations were conducted in an OFDM system that would be suitable for deployment in a 1×EV-DO system. The 1×EV-DO system is a time-synchronized cellular system that involves a sort of wideband time-division multiple access (TDMA) on the downlink. The TDMA aspect of 1×EV-DO along with the fact that all base stations in the network are tightly time-synchronized allows for an OFDM transmission to take place during a given time slot.

The total number of subcarriers-per-symbol was 400, of which 16 were dedicated to guard-interval. The OFDM symbol rate was 3.072 kHz. A rate ½, K=9 convolutional code was used along with a standard frequency-domain block interleaver. The selected wireless channel was a Vehicular A channel. Two PAM transmission cases were analyzed under static channel conditions, BPSK and 4-PAM. In order to verify that SSB transmission would be usable in a frequency reuse 2 scenario, the throughput for both cases was compared with a co-located interferer in the second sideband (also denoted as “alternate sideband interferer”) and without. This represents the worst-case interference scenario from the first-tier, which refers to neighboring cells, of downlink interferers in the network pattern of FIG. 7B. The results of the simulations reveal that there was no appreciable difference in throughput due to co-location of the co-located alternate sideband interferer comparing to the cases without interference.

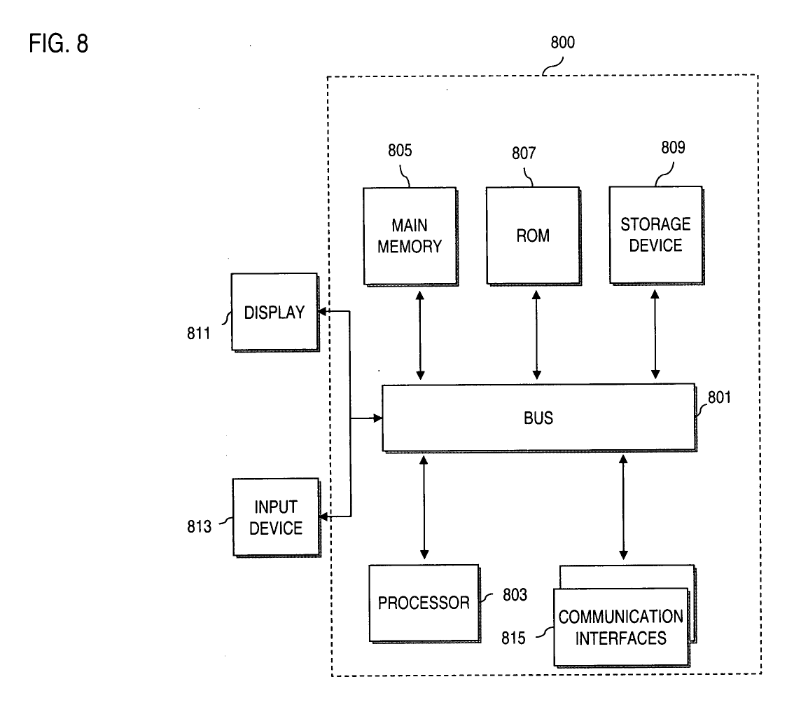

One of ordinary skill in the art would recognize that the processes for providing SSB OFDM may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 8.

FIG. 8 illustrates exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled via the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

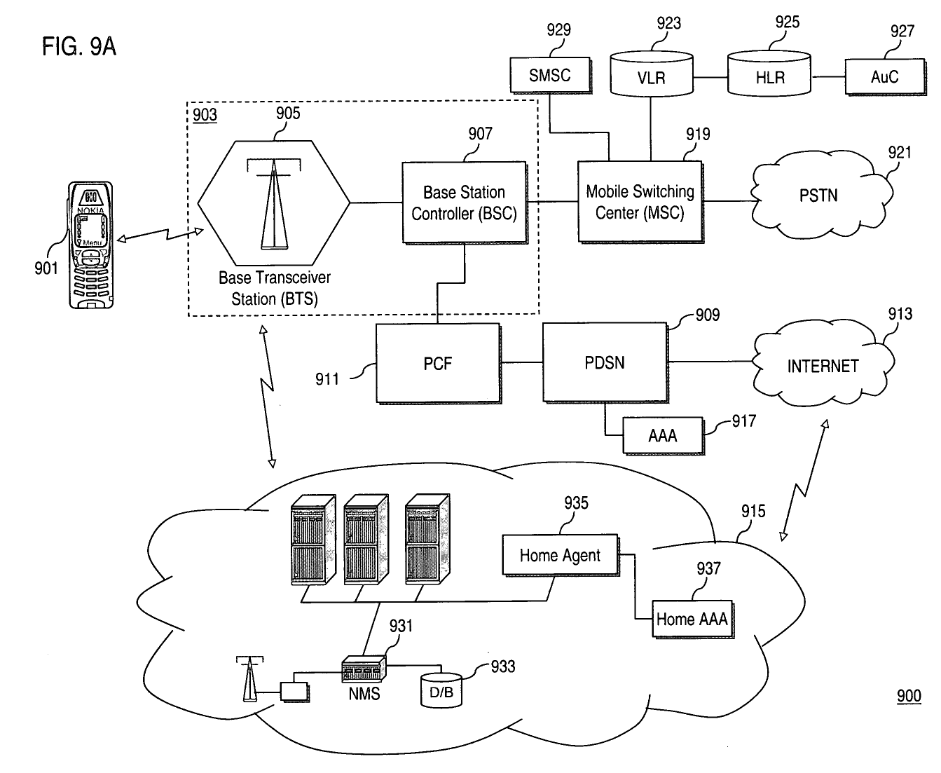

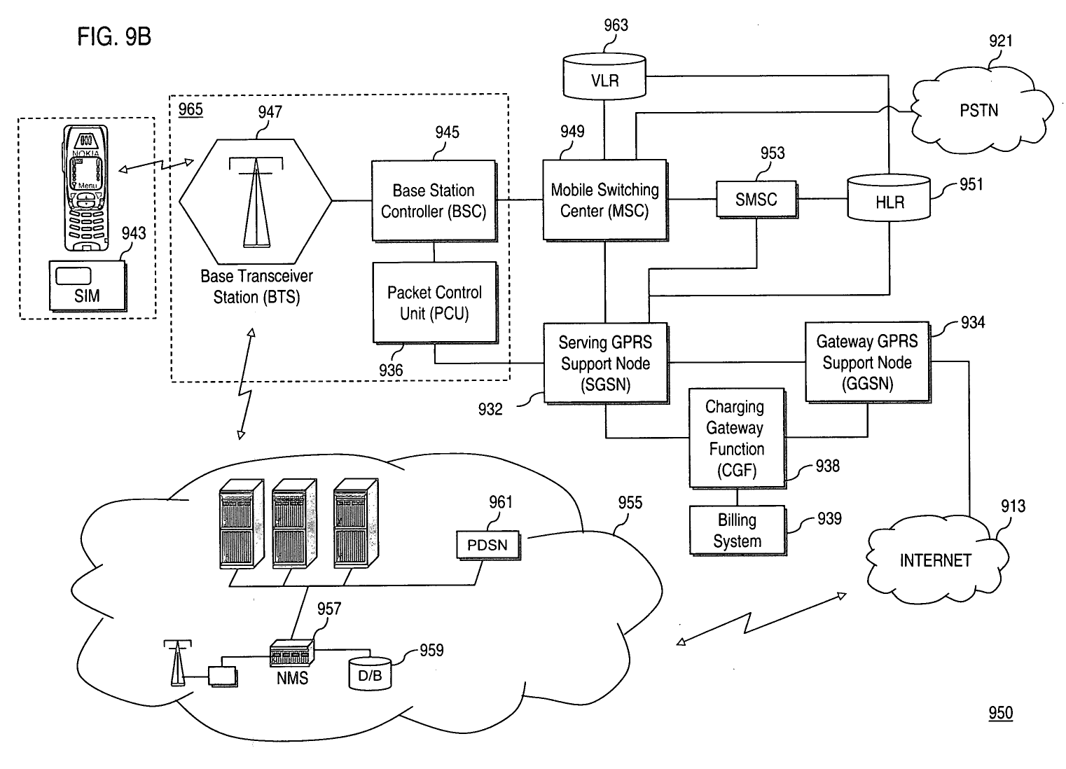

FIGS. 9A and 9B are diagrams of different cellular mobile phone systems capable of supporting various embodiments of the invention. FIGS. 9A and 9B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 900 includes mobile stations 901 (e.g., handsets, terminals, stations, units, devices, or any type of interface to the user (such as “wearable” circuitry, etc.)) in communication with a Base Station Subsystem (BSS) 903. According to one embodiment of the invention, the radio network supports Third Generation (3G) services as defined by the International Telecommunications Union (ITU) for International Mobile Telecommunications 2000 (IMT-2000).

In this example, the BSS 903 includes a Base Transceiver Station (BTS) 905 and Base Station Controller (BSC) 907. Although a single BTS is shown, it is recognized that multiple BTSs are typically connected to the BSC through, for example, point-to-point links. Each BSS 903 is linked to a Packet Data Serving Node (PDSN) 909 through a transmission control entity, or a Packet Control Function (PCF) 911. Since the PDSN 909 serves as a gateway to external networks, e.g., the Internet 913 or other private consumer networks 915, the PDSN 909 can include an Access, Authorization and Accounting system (AAA) 917 to securely determine the identity and privileges of a user and to track each user's activities. The network 915 comprises a Network Management System (NMS) 931 linked to one or more databases 933 that are accessed through a Home Agent (HA) 935 secured by a Home AAA 937.

Although a single BSS 903 is shown, it is recognized that multiple BSSs 903 are typically connected to a Mobile Switching Center (MSC) 919. The MSC 919 provides connectivity to a circuit-switched telephone network, such as the Public Switched Telephone Network (PSTN) 921. Similarly, it is also recognized that the MSC 919 may be connected to other MSCs 919 on the same network 900 and/or to other radio networks. The MSC 919 is generally collocated with a Visitor Location Register (VLR) 923 database that holds temporary information about active subscribers to that MSC 919. The data within the VLR 923 database is to a large extent a copy of the Home Location Register (HLR) 925 database, which stores detailed subscriber service subscription information. In some implementations, the HLR 925 and VLR 923 are the same physical database; however, the HLR 925 can be located at a remote location accessed through, for example, a Signaling System Number 7 (SS7) network. An Authentication Center (AuC) 927 containing subscriber-specific authentication data, such as a secret authentication key, is associated with the HLR 925 for authenticating users. Furthermore, the MSC 919 is connected to a Short Message Service Center (SMSC) 929 that stores and forwards short messages to and from the radio network 900.

During typical operation of the cellular telephone system, BTSs 905 receive and demodulate sets of reverse-link signals from sets of mobile units 901 conducting telephone calls or other communications. Each reverse-link signal received by a given BTS 905 is processed within that station. The resulting data is forwarded to the BSC 907. The BSC 907 provides call resource allocation and mobility management functionality including the orchestration of soft handoffs between BTSs 905. The BSC 907 also routes the received data to the MSC 919, which in turn provides additional routing and/or switching for interface with the PSTN 921. The MSC 919 is also responsible for call setup, call termination, management of inter-MSC handover and supplementary services, and collecting, charging and accounting information. Similarly, the radio network 900 sends forward-link messages. The PSTN 921 interfaces with the MSC 919. The MSC 919 additionally interfaces with the BSC 907, which in turn communicates with the BTSs 905, which modulate and transmit sets of forward-link signals to the sets of mobile units 901.

As shown in FIG. 9B, the two key elements of the General Packet Radio Service (GPRS) infrastructure 950 are the Serving GPRS Supporting Node (SGSN) 932 and the Gateway GPRS Support Node (GGSN) 934. In addition, the GPRS infrastructure includes a Packet Control Unit PCU (1336) and a Charging Gateway Function (CGF) 938 linked to a Billing System 939. A GPRS the Mobile Station (MS) 941 employs a Subscriber Identity Module (SIM) 943.

The PCU 936 is a logical network element responsible for GPRS-related functions such as air interface access control, packet scheduling on the air interface, and packet assembly and re-assembly. Generally the PCU 936 is physically integrated with the BSC 945; however, it can be collocated with a BTS 947 or a SGSN 932. The SGSN 932 provides equivalent functions as the MSC 949 including mobility management, security, and access control functions but in the packet-switched domain. Furthermore, the SGSN 932 has connectivity with the PCU 936 through, for example, a Fame Relay-based interface using the BSS GPRS protocol (BSSGP). Although only one SGSN is shown, it is recognized that that multiple SGSNs 931 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 945, any given BSC 945 generally interfaces with one SGSN 932. Also, the SGSN 932 is optionally connected with the HLR 951 through an SS7-based interface using GPRS enhanced Mobile Application Part (MAP) or with the MSC 949 through an SS7-based interface using Signaling Connection Control Part (SCCP). The SGSN/HLR interface allows the SGSN 932 to provide location updates to the HLR 951 and to retrieve GPRS-related subscription information within the SGSN service area. The SGSN/MSC interface enables coordination between circuit-switched services and packet data services such as paging a subscriber for a voice call. Finally, the SGSN 932 interfaces with a SMSC 953 to enable short messaging functionality over the network 950.

The GGSN 934 is the gateway to external packet data networks, such as the Internet 913 or other private customer networks 955. The network 955 comprises a Network Management System (NMS) 957 linked to one or more databases 959 accessed through a PDSN 961. The GGSN 934 assigns Internet Protocol (IP) addresses and can also authenticate users acting as a Remote Authentication Dial-In User Service host. Firewalls located at the GGSN 934 also perform a firewall function to restrict unauthorized traffic. Although only one GGSN 934 is shown, it is recognized that a given SGSN 932 may interface with one or more GGSNs 933 to allow user data to be tunneled between the two entities as well as to and from the network 950. When external data networks initialize sessions over the GPRS network 950, the GGSN 934 queries the HLR 951 for the SGSN 932 currently serving a MS 941.

The BTS 947 and BSC 945 manage the radio interface, including controlling which Mobile Station (MS) 941 has access to the radio channel at what time. These elements essentially relay messages between the MS 941 and SGSN 932. The SGSN 932 manages communications with an MS 941, sending and receiving data and keeping track of its location. The SGSN 932 also registers the MS 941, authenticates the MS 941, and encrypts data sent to the MS 941.

FIG. 10 is a diagram of exemplary components of a mobile station (e.g., handset) capable of operating in the systems of FIGS. 9A and 9B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system (e.g., systems of FIG. 14A or 14B), via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

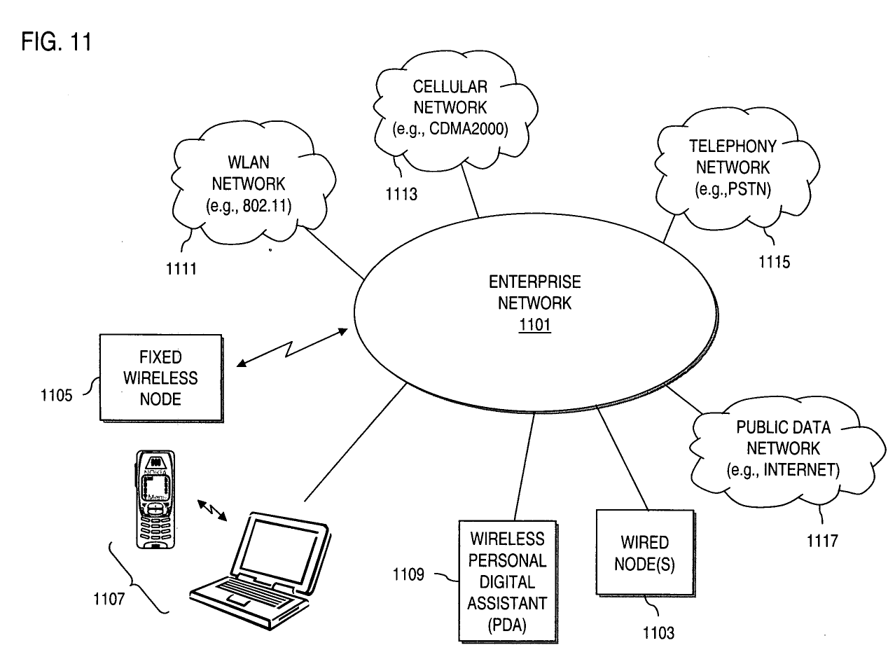

FIG. 11 shows an exemplary enterprise network, which can be any type of data communication network utilizing packet-based and/or cell-based technologies (e.g., Asynchronous Transfer Mode (ATM), Ethernet, IP-based, etc.). The enterprise network 1101 provides connectivity for wired nodes 1103 as well as wireless nodes 1105-1109 (fixed or mobile), which are each configured to perform the processes described above. The enterprise network 1101 can communicate with a variety of other networks, such as a WLAN network 1111 (e.g., IEEE 802.11), a cdma2000 cellular network 1113, a telephony network 1115 (e.g., PSTN), or a public data network 1117 (e.g., Internet).

According to various embodiments of the invention, a single sideband (SSB) orthogonal frequency division multiplexing (OFDM) system is disclosed for alleviating the co-channel interference and obtaining a frequency reuse factor of 2 in an OFDM system deployed cellular environment that normally would have a frequency reuse factor of 1. This is accomplished by having alternating cells in the system transmit in such a way that the neighboring cells do not transmit over the same sideband to the extent possible. This provides an OFDM system that is suitable for overlay deployment in a reuse-1 system such as CDMA.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a data vector;
transforming the data vector by an inverse of a sinusoidal transform;
extending the transformed vector symmetrically to output orthogonal frequency division multiplexing (OFDM) symbols; and
generating a single sideband signal representing the OFDM symbols, wherein the single sideband signal is transmitted according to a predetermined scheme to minimize co-channel interference.

2. A method according to claim 1, wherein the sinusoidal transform includes a discrete cosine transform, a discrete sine transform or a discrete Fourier transform.

3. A method according to claim 1, wherein the single sideband signal is generated for use within a first transmission area, and the predetermined scheme provides for utilizing a different single sideband signal for a second transmission area neighboring the first transmission area.

4. A method according to claim 3, wherein the transmission areas are cells of a cellular system.

5. A method according to claim 1, further comprising:
for each of the OFDM symbols, adding a guard interval to respective ones of the OFDM symbols; and
converting the OFDM symbols into a serial stream of symbols.

6. A method according to claim 1, wherein the single sideband signal is pulse amplitude modulated.

7. An apparatus comprising:
a transform logic configured to transform a received data vector by an inverse of a sinusoidal transform; and
an add symmetric extension logic configured to extend the transformed vector symmetrically to output orthogonal frequency division multiplexing (OFDM) symbols,
wherein a single sideband signal representing the OFDM symbols is generated, the single sideband signal being transmitted according to a predetermined scheme to minimize co-channel interference.

8. An apparatus according to claim 7, wherein the sinusoidal transform includes a discrete cosine transform, a discrete sine transform or a discrete Fourier transform.

9. An apparatus according to claim 7, wherein the single sideband signal is generated for use within a first transmission area, and the predetermined scheme provides for utilizing a different single sideband signal for a second transmission area neighboring the first transmission area.

10. An apparatus according to claim 9, wherein the transmission areas are cells of a cellular system.

11. An apparatus according to claim 7, further comprising:
a guard interval and conversion logic configured to, for each of the OFDM symbols, add a guard interval to respective ones of the OFDM symbols, the guard interval logic being further configured to convert the OFDM symbols into a serial stream of symbols.

12. An apparatus according to claim 7, wherein the single sideband signal is pulse amplitude modulated.

13. A system comprising the apparatus of claim 7, the system further comprising:
a keyboard configured to receive input from a user for initiation of a communication session; and
a display configured to display the input.

14. A method comprising:
receiving a single sideband signal that represents orthogonal frequency division multiplexing (OFDM) symbols, wherein the single sideband signal having been transmitted according to a predetermined scheme to minimize co-channel interference, the OFDM symbols representing a symmetric data vector;
transforming the OFDM symbols by applying a sinusoidal transform; and
outputting the data vector from the transformed OFDM symbols.

15. A method according to claim 14, wherein the sinusoidal transform includes a discrete cosine transform, a discrete sine transform or a discrete Fourier transform.

16. A method according to claim 14, wherein the single sideband signal is generated for use within a first transmission area, and the predetermined scheme provides for utilizing a different single sideband signal for a second transmission area neighboring the first transmission area.

17. A method according to claim 16, wherein the transmission areas are cells of a cellular system.

18. A method according to claim 14, further comprising:
for each of the OFDM symbols, removing a guard interval to respective ones of the OFDM symbols; and
converting the received single sideband signal into a parallel stream of OFDM symbols.

19. A method according to claim 14, wherein the single sideband signal is pulse amplitude modulated.

20. An apparatus comprising:
means for receiving a single sideband signal that represents orthogonal frequency division multiplexing (OFDM) symbols, wherein the single sideband signal having been transmitted according to a predetermined scheme to minimize co-channel interference, the OFDM symbols representing a symmetric data vector;
means for transforming the OFDM symbols by applying a sinusoidal transform; and
means for outputting the data vector from the transformed OFDM symbols.

21. An apparatus according to claim 20, wherein the sinusoidal transform includes a discrete cosine transform, a discrete sine transform or a discrete Fourier transform.

22. An apparatus according to claim 20, wherein the single sideband signal is generated for use within a first transmission area, and the predetermined scheme provides for utilizing a different single sideband signal for a second transmission area neighboring the first transmission area.

23. An apparatus according to claim 22, wherein the transmission areas are cells of a cellular system.

24. An apparatus according to claim 20, further comprising:
for each of the OFDM symbols, means for removing a guard interval to respective ones of the OFDM symbols; and
means for converting the received single sideband signal into a parallel stream of OFDM symbols.

25. An apparatus according to claim 20, wherein the single sideband signal is pulse amplitude modulated.

26. A system comprising the apparatus of claim 20, the system further comprising:
a keyboard configured to receive input from a user for initiation of a communication session; and
a display configured to display the input.

27. A method comprising:
assigning a first transmission area to use a first single sideband orthogonal frequency division multiplexing (OFDM) signal; and
assigning a second transmission area to use a second single sideband OFDM signal,
wherein the first single sideband OFDM signal is different from the second single sideband OFDM signal, and each of the single sideband OFDM signals is based on sinusoidal transform.

28. A method according to claim 27, wherein the sinusoidal transform includes a discrete cosine transform, a discrete sine transform or a discrete Fourier transform.

29. A method according to claim 27, wherein the sinusoidal transform is a discrete cosine transform, and each of the single sideband OFDM signals is further based on a discrete sine transform.

30. A system comprising:
a processor configured to assign a first transmission area to use a first single sideband orthogonal frequency division multiplexing (OFDM) signal, the processor being further configured to assign a second transmission area to use a second single sideband OFDM signal,
wherein the first single sideband OFDM signal is different from the second single sideband OFDM signal, and each of the single sideband OFDM signals is based on sinusoidal transform.

31. A system according to claim 30, wherein the sinusoidal transform includes a discrete cosine transform, a discrete sine transform or a discrete Fourier transform.

32. A system according to claim 30, wherein the sinusoidal transform is a discrete cosine transform, and each of the single sideband OFDM signals is further based on a discrete sine transform.
